(19) United States
(12) Patent Application Publication
(10) Pub. No.: US 2025/0355932 A1
(43) Pub. Date: Nov. 20, 2025

(54) IMAGE RETRIEVAL METHOD, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Rongcheng TU, Shenzhen (CN)

(21) Appl. No.: 19/228,348

(22) Filed: Jun. 4, 2025

Related U.S. Application Data
(63) Continuation of application No. PCT/CN2024/081383, filed on Mar. 13, 2024.

(30) Foreign Application Priority Data
May 12, 2023 (CN) 202310538798.4

(51) Int. Cl. G06F 16/58; G06F 16/532; G06F 16/583

(52) U.S. Cl. CPC G06F 16/5866; G06F 16/532; G06F 16/583

(57) ABSTRACT

An image retrieval method includes acquiring an image retrieval condition, the image retrieval condition comprising a reference image and modification text, the modification text being configured to indicate a modification expectation for the reference image; composing the reference image and the modification text, to obtain an image-text composition; acquiring a plurality of candidate images, and determining, for a candidate image, a first similarity between the candidate image and the image-text composition, and a second similarity between the candidate image and the modification text; and determining at least one target image satisfying the image retrieval condition from the plurality of candidate images with reference to the first similarity and the second similarity.

### CROSS-REFERENCES TO RELATED APPLICATIONS

This application is a continuation application of PCT Patent Application No. PCT/CN2024/081383, filed on Mar. 13, 2024, which claims priority to Chinese Patent Application No. 202310538798.4, filed on May 12, 2023, all of which is incorporated by reference in its entirety.

### FIELD OF THE TECHNOLOGY

The present disclosure relates to the field of computer technologies, and in particular, to an image retrieval method and apparatus, an electronic device, a computer-readable storage medium, and a computer program product.

### BACKGROUND OF THE DISCLOSURE

Artificial intelligence (AI) involves a theory, a method, a technology, and an application system that uses a digital computer or a machine controlled by the digital computer to simulate, extend, and expand human intelligence, sense an environment, acquire knowledge, and use the knowledge to obtain an optimal result. In other words, AI is an integrated technology in computer science that attempts to understand the essence of intelligence and produce a new intelligent machine that can react in a manner similar to human intelligence. Artificial intelligence involves studying the design principles and implementation methods of various intelligent machines, enabling the machines to have functions of perception, reasoning, and decision-making.

Typically, by modifying the text to match the labels of candidate images, corresponding target images are retrieved. However, when the semantics of the modified text are complex, the retrieved target image often fails to meet the modification expectations, resulting in poor accuracy of image retrieval.

### SUMMARY

One embodiment of the present disclosure provides an image retrieval method. The method includes acquiring an image retrieval condition, the image retrieval condition including a reference image and modification text, the modification text being configured to indicate a modification expectation for the reference image; composing the reference image and the modification text, to obtain an image-text composition; acquiring a plurality of candidate images, and determining, for a candidate image, a first similarity between the candidate image and the image-text composition, and a second similarity between the candidate image and the modification text; and determining at least one target image satisfying the image retrieval condition from the plurality of candidate images with reference to the first similarity and the second similarity.

Another embodiment of the present disclosure provides an electronic device. The electronic device includes one or more processors and a memory containing a computer program that, when being executed, causes the one or more processors to perform: acquiring an image retrieval condition, the image retrieval condition including a reference image and modification text, the modification text being configured to indicate a modification expectation for the reference image; composing the reference image and the modification text, to obtain an image-text composition; acquiring a plurality of candidate images, and determining, for a candidate image, a first similarity between the candidate image and the image-text composition, and a second similarity between the candidate image and the modification text; and determining at least one target image satisfying the image retrieval condition from the plurality of candidate images with reference to the first similarity and the second similarity.

Another embodiment of the present disclosure provides a non-transitory computer readable storage medium containing a computer program that, when being executed, causes at least one processor to perform: acquiring an image retrieval condition, the image retrieval condition including a reference image and modification text, the modification text being configured to indicate a modification expectation for the reference image; composing the reference image and the modification text, to obtain an image-text composition; acquiring a plurality of candidate images, and determining, for a candidate image, a first similarity between the candidate image and the image-text composition, and a second similarity between the candidate image and the modification text; and determining at least one target image satisfying the image retrieval condition from the plurality of candidate images with reference to the first similarity and the second similarity.

### BRIEF DESCRIPTION OF THE DRAWINGS

FIG. 1 is a schematic architectural diagram of an image retrieval system according to an embodiment of the present disclosure.

FIG. 2 is a schematic structural diagram of an electronic device applied to image retrieval according to an embodiment of the present disclosure.

FIG. 3 is a first schematic flowchart of an image retrieval method according to an embodiment of the present disclosure.

FIG. 4 is a second schematic flowchart of an image retrieval method according to an embodiment of the present disclosure.

FIG. 5 is a third schematic flowchart of an image retrieval method according to an embodiment of the present disclosure.

FIG. 6 is a fourth schematic flowchart of an image retrieval method according to an embodiment of the present disclosure.

FIG. 7 is a schematic diagram of a principle of an image retrieval condition according to an embodiment of the present disclosure.

FIG. 8 is a schematic diagram of a principle of a first prediction network according to an embodiment of the present disclosure.

FIG. 9 is a schematic diagram of a principle of a second prediction network according to an embodiment of the present disclosure.

FIG. 10 is a schematic diagram of a principle of an image retrieval method according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation on the present disclosure. All other embodiments obtained by those of ordinary skill in the art without creative efforts fall within the scope of protection of the present disclosure.

In the following descriptions, related “some embodiments” describe a subset of all possible embodiments. However, the “some embodiments” may be the same subset or different subsets of all the possible embodiments, and may be combined with each other without conflict.

In the following description, the involved terms “first/second/third” are merely intended to distinguish between similar objects rather than describing specific orders. The terms “first/second/third”are interchangeable in proper circumstances to enable the embodiments of the present disclosure to be implemented in other orders than those illustrated or described herein.

Unless otherwise defined, meanings of all technical and scientific terms used herein are the same as those usually understood by those skilled in the art to which the present disclosure belongs. Terms used herein are merely intended to describe the embodiments of the present disclosure, but are not intended to limit the present disclosure.

Before the embodiments of the present disclosure are further described in detail, a description is made to nouns and terms in the embodiments of the present disclosure, and the nouns and terms in the embodiments of the present disclosure are applicable to the following explanations.

1) Artificial intelligence (AI): AI involves a theory, a method, a technology, and an application system that employ a digital computer or a machine controlled by the digital computer to simulate, extend, and expand human intelligence, perceive an environment, acquire knowledge, and use knowledge to obtain an optimal result. The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration.

2) Convolutional neuron network (CNN): it is a type of feedforward neural network that includes convolutional computation and that has a deep structure, and is one of representative algorithms of deep learning. The convolutional neural network has a representation learning capability, and can perform shift-invariant classification on an input image based on a hierarchical structure thereof.

3) Convolutional layer: each convolutional layer in the convolutional neural network includes several convolutional units, and a parameter of each convolutional unit is obtained through optimization by using a back propagation algorithm. An objective of the convolution operation is to extract different features of an input. A first convolution layer may only extract some low-level features such as an edge, a line, and an angle. A multi-layer network can iteratively extract more complex features from the low-level features.

4) Pooling layer: after the convolutional layer performs feature extraction, an output feature map is transferred to the pooling layer for feature selection and information filtering. The pooling layer includes a preset pooling function, which replaces a result of a single point in the feature map with a feature map statistic of an adjacent region thereof. The operation of selecting a pooling region by the pooling layer is the same as the operation of scanning the feature map by the convolution kernel, and is controlled by a pooling size, a step length, and filling.

5) Fully-connected Layer: the fully-connected layer in the convolutional neural network is equivalent to a hidden layer in a suitable feedforward neural network. The fully-connected layer is located at the last part of a hidden layer of a convolutional neural network, and transfers a signal only to another fully-connected layer. The feature map loses a spatial topology structure in the fully-connected layer, is expanded into a vector, and passes an excitation function.

6) Game program: the game program may be any one of a massive multiplayer online role-playing game (MMORPG), a first-person shooting game (FPS), a third-person shooting game, a multiplayer online battle arena (MOBA) game, a virtual reality application, a three-dimensional map program, a simulated program, or a multiplayer gunfight survival game.

In an implementation process of the embodiments of the present disclosure, the applicant has found that the related art has the following problems. In recent years, with the rapid development of the Internet, multimedia data explosively grows in a plurality of forms such as text, an image, and audio, and various same or similar objects emerge one by one. Multimedia retrieval has become a basic task for users to flexibly acquire information. Therefore, to meet increasingly complex retrieval requirements of users, Linguistic-Visual Composed Query Based Image Retrieval (LVCQ-IR) is put forward and attracts increasing attention. As one of the most popular multimedia retrieval models nowadays, LVCQ-IR aims to take a reference image and a piece of expected modification text of the image as query input, and retrieve a corresponding target image through database query. Because the input text expresses an intention of modifying the reference image, an existing retrieval model applied to LVCQ-IR mainly focuses on designing a synthetic network, that is, a feature representation of the reference image and a feature representation of intention text are fused into a composed query representation, and the composed query representation is made to be as close to a feature representation of the target image as possible through model training.

However, in a model design process, the fused composed query representation will be affected by the reference image to a large extent, whereby some or even all information in the intention text is ignored. For example, if a non-target image A is very similar to a reference image B used during training, A is not matched with a description in the intention text, and a real target image C is matched with the description in the intention text, the following situation may occur during model training: the fused composed query representation is increasingly close to a feature representation of A, rather than close to a representation of the real target image C, which results in an incorrect retrieval result, and relatively poor accuracy of image retrieval.

To validate the effectiveness of the embodiments of the present disclosure in an actual scenario, an experiment is performed in the embodiments of the present disclosure on a public data set. The public data set is also employed for interactive retrieval based on dialog. 10000 groups of triples are selected for training, and 4568 groups of triples are selected for testing. In the embodiments of the present disclosure, the following evaluation indicators are adopted to validate the performance of hash retrieval:

Accuracy (R@K): it is a ratio of returned correct queries to the first K results. In a Fashion-IQ data set, K is set to 10 or 50, and in a Shoed data set. K is set to 1 or 10 or 50.

Performance parameters (Rmeans): it is a mean value of all R@K values and is configured to evaluate the overall retrieval performance.

In an algorithm framework, in the embodiments of the present disclosure, a Contrastive Language-Image Pre-training (CLIP) model is selected to initialize a model, learning optimization is performed on the model by using pytorch based on an Adam optimizer, and the model is compared with Cox-Ross-Rubinstein (CRR) which is the best method currently, to validate the effectiveness of the present disclosure. Results are shown in Table 1. It can be seen from Table 1 that, compared with the related art, the performance improvement of at least 3% is obtained in the embodiments of the present disclosure, and the optimal retrieval performance is obtained. In addition, the superiority of the embodiments of the present disclosure on the LVCQ-IR task may be proved.

TABLE 1
Performance comparison of the present disclosure and related art

| | R@K | Rmeans | R@K | Rmeans |
|---|---|---|---|---|
| | (data | (data | (data | (data |
| | set A) | set A) | set B) | set B) |
| Related art | 18.41 | 56.38 | 79.92 | 51.57 |
| This application | 23.56 | 59.87 | 81.18 | 54.87 |

The embodiments of the present disclosure provide an image retrieval method and apparatus, an electronic device, a computer-readable storage medium, and a computer program product, to effectively improve accuracy of image retrieval. In one embodiment, mage retrieval condition including the reference image and the modification text and the plurality of candidate images are acquired, the first similarity between each candidate image and the image-text composition (i.e., reference image-modification text composition), and the second similarity between each candidate image and the modification text are determined, and the target image satisfying the image retrieval condition is determined from the plurality of candidate images with reference to the first similarity and the second similarity. In this way, the retrieved target image satisfying the image retrieval condition is determined based on the first similarity between the candidate image and the image-text composition, which can effectively ensure that the determined target image can meet retrieval requirements of both the reference image and the modification text. In addition, the target image is also determined based on the second similarity between the candidate image and the modification text, which can enhance the impact of the modification expectation of the modification text on the determined target image. Therefore, the target image can highly satisfy the modification expectation of the modification text, and accuracy of image retrieval is effectively improved.

The following describes exemplary application of an image retrieval system provided in the embodiments of the present disclosure.

FIG. 1 is a schematic architectural diagram of an image retrieval system 100 according to an embodiment of the present disclosure. A terminal (exemplarily, a terminal 400 is shown) is connected to a server 200 over a network 300. The network 300 may be a wide area network, a local area network, or a combination of the two.

The terminal 400 is configured to allow a user to use a client 410, and display a target image on a graphic interface 410-1 (exemplarily, a graphic interface 410-1 is shown). The terminal 400 and the server 200 are connected to each other over a wired or wireless network.

In some embodiments, the server 200 may be an independent physical server, or may be a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and AI platform. The terminal 400 may be a smartphone, a tablet computer, a laptop, a desktop computer, a smart speaker, a smartwatch, an on-board terminal, or the like, but is not limited thereto. The electronic device provided in the embodiments of the present disclosure may be implemented as a terminal or a server. The terminal and the server may be connected directly or indirectly by using a wired or wireless communication protocol. This is not limited according to the embodiments of the present disclosure.

In some embodiments, the server 200 acquires an image retrieval condition, acquires a plurality of candidate images, determines a target image satisfying the image retrieval condition, and transmits the target image to the terminal 400.

In some other embodiments, the server 200 acquires an image retrieval condition, acquires a plurality of candidate images, determines a first similarity between each candidate image and an image-text composition (i.e., reference image-modification text composition), and a second similarity between each candidate image and the modification text, and transmits the first similarity and the second similarity to the terminal 400. The terminal 400 determines a target image satisfying the image retrieval condition from the plurality of candidate images with reference to the first similarity and the second similarity.

In some other embodiments, the embodiments of the present disclosure may be implemented by using a cloud technology. The cloud technology refers to a hosting technology that unifies a series of resources such as hardware, software, and networks within a wide area network or a local area network to implement calculation, storage, processing, and sharing of data.

The cloud technology is a generic term of a network technology, an information technology, an integration technology, a management platform technology, and an application technology based on application of a cloud computing business model. The resources may form a resource pool and are used on demand, which is flexible and convenient. The cloud computing technology will become an important support. Backend services of a technology network system require a lot of computing and storage resources.

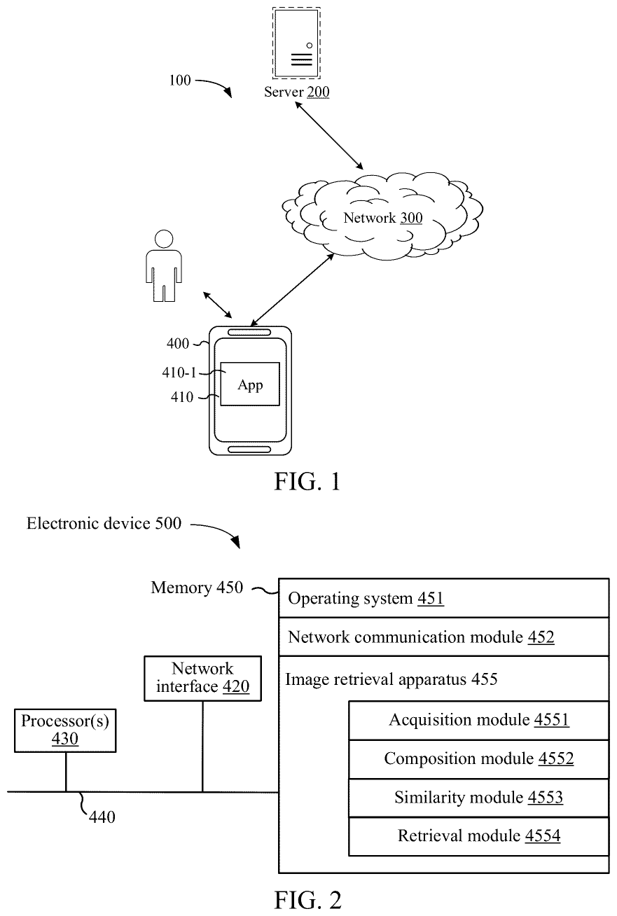

FIG. 2 is a schematic structural diagram of an electronic device 500 applied to image retrieval according to an embodiment of the present disclosure. The electronic device 500 shown in FIG. 2 may be the server 200 or the terminal 400 in FIG. 1. The electronic device 500 shown in FIG. 2 includes: at least one processor 430, a memory 450, and at least one network interface 420. The components in the electronic device 500 are coupled together through a bus system 440. The bus system 440 is configured to enable connection and communication between these components. In addition to a data bus, the bus system 440 further includes a power bus, a control bus, and a state signal bus. However, for clarity, various buses are marked as the bus system 440 in FIG. 2.

The processor 430 may be an integrated circuit chip having a signal processing capability, such as a general-purpose processor, a digital signal processor (DSP) or another programmable logic device (PLD), a discrete gate or transistor logic device, a discrete hardware component, or the like. The general-purpose processor may be a microprocessor or any suitable processor.

The memory 450 may be a removable memory, an irremovable memory, or a combination of the two. Exemplary hardware devices include a solid memory, a hard disk drive, an optical disk drive, and the like. In an embodiment, the memory 450 includes one or more storage devices physically located away from the processor 430.

The memory 450 includes a volatile memory or a non-volatile memory, or may include both a volatile memory and a non-volatile memory. The non-volatile memory may be a read-only memory (ROM), and the volatile memory may be a random-access memory (RAM). The memory 450 described in the embodiments of the present disclosure aims to include any suitable type of memory.

In some embodiments, the memory 450 can store data to support various operations. Examples of the data include a program, a module, or a data structure or a subset or a superset thereof, which are exemplarily described below.

An operating system 451 includes system programs configured to process various basic system services and perform hardware-related tasks, such as a framework layer, a core library layer, and a driver layer, which are configured to implement various basic services and process hardware-based tasks.

A network communication module 452 is configured to reach another electronic device via one or more (wired or wireless) network interfaces 420. Exemplarily, the network interface 420 includes: Bluetooth, Wireless Fidelity (Wi-Fi), Universal Serial Bus (USB), and the like.

In some embodiments, the image retrieval apparatus provided in the embodiments of the present disclosure may be implemented in the form of software. FIG. 2 shows an image retrieval apparatus 455 stored in the memory 450. The apparatus 455 may be software in the form of a program, a plug-in, or the like, and includes the following software modules: an acquisition module 4551, a composition module 4552, a similarity module 4553, and a retrieval module 4554. These modules are logical, and can be combined or further split according to functions implemented. The functions of the modules are described below.

In some other embodiments, the image retrieval apparatus provided in the embodiments of the present disclosure may be implemented in the form of hardware. As an example, the image retrieval apparatus provided in the embodiments of the present disclosure may be a processor in the form of a hardware decoding processor, which is programmed to perform the image retrieval method provided in the embodiments of the present disclosure. For example, the processor in the form of a hardware decoding processor may adopt one or more application specific integrated circuits (ASICs), a DSP, a PLD, a complex PLD (CPLD), a field-programmable gate array (FPGA), or another electronic component.

In some embodiments, the terminal or the server may implement the image retrieval method provided in the embodiments of the present disclosure by running a computer program or computer-executable instructions. For example, the computer program may be a native program (such as a dedicated image retrieval program) or a software module in an operating system, such as an image retrieval module that may be embedded in any program (such as an instant messaging client, an album program, an electronic map client, or a navigation client) or may be a native application (APP), namely, a program that needs to be installed in the operating system for running. In summary, the foregoing computer program may be an application program, a module, or a plug-in in any form.

The image retrieval method provided in the embodiments of the present disclosure is described with reference to the exemplary application and implementations of the terminal or server provided in the embodiments of the present disclosure.

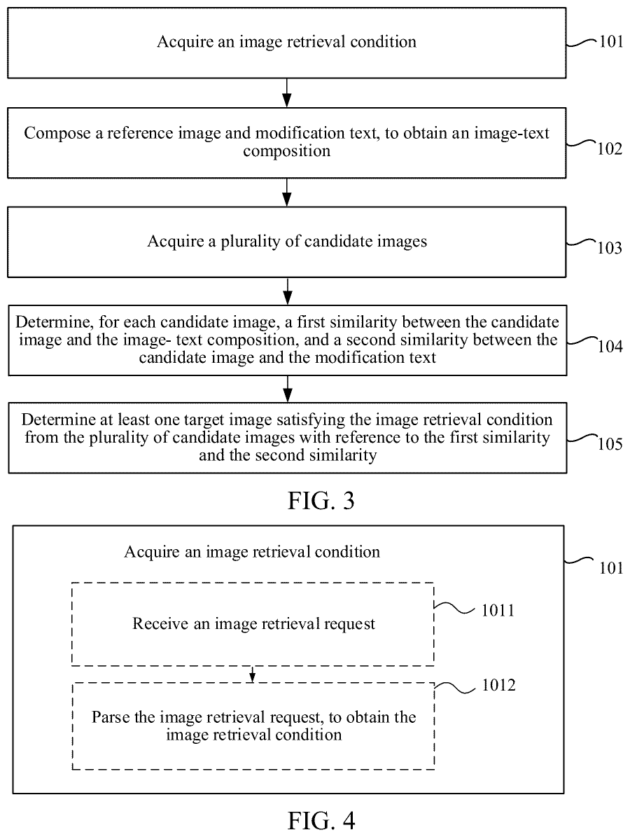

FIG. 3 is a first schematic flowchart of an image retrieval method according to an embodiment of the present disclosure. Descriptions are provided with reference to operation 101 to operation 105 shown in FIG. 3. The image retrieval method provided in the embodiments of the present disclosure may be implemented by a server or a terminal alone, or may be cooperatively implemented by a server and a terminal. The following describes an example in which the method is implemented by a server alone.

Operation 101: Acquire an image retrieval condition.

In some embodiments, the image retrieval condition includes a reference image and modification text. The modification text is configured to indicate a modification expectation for the reference image.

In some embodiments, the image retrieval condition is configured to retrieve a target image satisfying the modification expectation for the reference image.

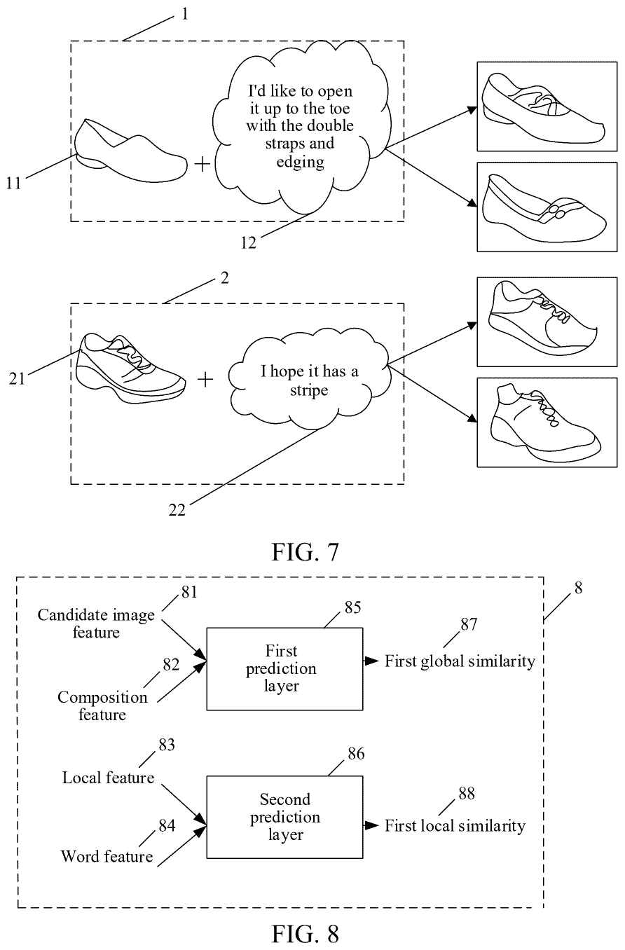

Refer to FIG. 7. As an example, FIG. 7 is a schematic diagram of a principle of an image retrieval condition according to an embodiment of the present disclosure. An image retrieval condition 1 includes a reference image 11 and modification text 12. The modification text 12 is “I'd like to open it up to the toe with the double straps and edging” and is configured to indicate a modification expectation for the reference image 11. The image retrieval condition 1 is configured to retrieve a target image satisfying the modification expectation for the reference image 11.

Refer to FIG. 7. As an example, FIG. 7 is a schematic diagram of a principle of an image retrieval condition according to an embodiment of the present disclosure. An image retrieval condition 2 includes a reference image 21 and modification text 22. The modification text 22 is “I'd like to open it up to the toe with the double straps and edging” and is configured to indicate a modification expectation for the reference image 21. The image retrieval condition 2 is configured to retrieve a target image satisfying the modification expectation for the reference image 21.

Refer to FIG. 4. In some embodiments, FIG. 4 is a second schematic flowchart of an image retrieval method according to an embodiment of the present disclosure. Operation 101 shown in FIG. 3 is implemented through operation 1011 and operation 1012 in FIG. 4.

Operation 1011: Receive an image retrieval request.

In some embodiments, a terminal generates the image retrieval request based on an image retrieval instruction and transmits the image retrieval request to a server, and the server receives the image retrieval request.

In some embodiments, the image retrieval request carries an image retrieval condition, and is generated by the terminal based on the image retrieval instruction. The image retrieval instruction is configured to instruct to perform image retrieval based on an input reference image and input modification text.

Operation 1012: Parse the image retrieval request, to obtain an image retrieval condition.

In some embodiments, because the image retrieval request carries the image retrieval condition, the image retrieval condition carried in the image retrieval request may be obtained by parsing the image retrieval request.

Operation 102: Compose the reference image and the modification text, to obtain an image-text composition (i.e., a reference image-modification text composition).

As an example, the composition refers to a processing process of composing to-be-composed objects (the reference image and the modification text).

In some embodiments, operation 102 may be implemented in the following manner: a union set of the reference image and the modification text is determined as the image-text composition.

Refer to FIG. 7. As an example, the reference image 11 and the modification text 12 are composed, to obtain a image-text composition; and the reference image 21 and the modification text 22 are composed, to obtain a image-text composition.

Operation 103: Acquire a plurality of candidate images.

In some embodiments, the candidate images are images pre-stored in a database, and the candidate images include a target image satisfying the modification expectation for the reference image that is indicated by the modification text.

Operation 104: Determine, for each candidate image, a first similarity between the candidate image and the image-text composition, and a second similarity between the candidate image and the modification text.

In some embodiments, the first similarity between the candidate image and the image-text composition is configured to indicate overall and local similarities between the candidate image and the image-text composition. The second similarity between the candidate image and the modification text is configured to indicate overall and local similarities between the candidate image and the modification text.

In some embodiments, values of the first similarity and the second similarity are positively correlated to corresponding similarities.

In this way, the first similarity between each candidate image and the image-text composition and the second similarity between each candidate image and the modification text are determined. Because the first similarity and the second similarity can accurately reflect the overall and local similarities between the candidate image and the image-text composition, and the overall and local similarities between the candidate image and the modification text, similarities are comprehensively measured from multiple perspectives, namely, the overall perspective and the local perspective. In this way, accuracy of the determined first similarity and second similarity is effectively improved.

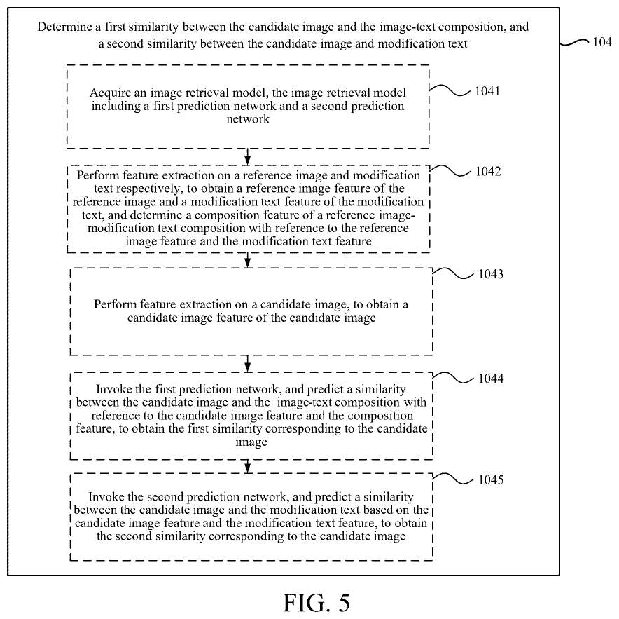

Refer to FIG. 5. In some embodiments, FIG. 5 is a third schematic flowchart of an image retrieval method according to an embodiment of the present disclosure. Operation 104 shown in FIG. 3 may be implemented through operation 1041 to operation 1045 shown in FIG. 5.

Operation 1041: Acquire an image retrieval model, the image retrieval model including a first prediction network and a second prediction network.

In some embodiments, the image retrieval model may be an LVCQ-IR model configured to retrieve a target image satisfying a modification expectation for a reference image.

In some embodiments, the first prediction network is configured to predict a similarity between a candidate image and an image-text composition, and the second prediction network is configured to predict a similarity between the candidate image and modification text.

In some embodiments, operation 1041 may be implemented in the following manner: an image retrieval condition sample and a target image sample are acquired, the image retrieval condition sample including a reference image sample and a modification text sample, the modification text sample being configured to indicate a modification expectation for the reference image sample, and the target image sample satisfying the modification expectation; the reference image sample and the modification text sample are composed, to obtain an image-text composition sample; a plurality of candidate images are acquired, the candidate images including the target image sample; for each candidate image, an initial image retrieval model is invoked, and similarity prediction is performed on the candidate image based on the candidate image, the reference image sample, and the modification text sample, to obtain a third similarity between the candidate image and the image-text composition sample, and a fourth similarity between the candidate image and the modification text sample; and the initial image retrieval model is trained with reference to the third similarity and the fourth similarity, to obtain the image retrieval model.

In some embodiments, the initial image retrieval model includes a first initial prediction network and a second initial prediction network. A network structure of the first initial prediction network is the same as that of the first prediction network of the image retrieval model, and a network structure of the second initial prediction network is the same as that of the second prediction network of the image retrieval model.

In some embodiments, the operation of invoking the initial image retrieval model, and performing similarity prediction on the candidate image based on the candidate image, the reference image sample, and the modification text sample, to obtain a third similarity between the candidate image and the image-text composition sample, and a fourth similarity between the candidate image and the modification text sample may be implemented in the following manner: feature extraction is performed on the reference image sample and the modification text sample, respectively, to obtain a reference image feature of the reference image sample and a modification text feature of the modification text sample, and a composition sample feature of the image-text composition sample is determined with reference to the reference image feature and the modification text feature; feature extraction is performed on the candidate image, to obtain a candidate image feature of the candidate image; the first initial prediction network is invoked, a similarity between the candidate image and the image-text composition sample is predicted based on the candidate image feature and the composition sample feature, to obtain the third similarity between the candidate image and the image-text composition sample; and the second initial prediction network is invoked, and a similarity between the candidate image and the modification text sample is predicted based on the candidate image feature and the modification text feature, to obtain the fourth similarity between the candidate image and the modification text sample.

In some embodiments, the third similarity includes a third global similarity and a third local similarity, the first initial prediction network includes a first initial prediction layer and a second initial prediction layer, and the operation of invoking the first initial prediction network, and predicting a similarity between the candidate image and the image-text composition sample based on the candidate image feature and the composition sample feature, to obtain the third similarity between the candidate image and the image-text composition sample may be implemented in the following manner: the first initial prediction layer is invoked, and an overall similarity between the candidate image and the image-text composition sample is predicted based on the candidate image feature and the composition sample feature, to obtain the third global similarity corresponding to the candidate image; feature segmentation is performed on the composition sample feature, to obtain a plurality of local sample features corresponding to the composition sample feature, and feature segmentation is performed on the modification text feature of the modification text sample, to obtain a word feature corresponding to each word in the modification text sample; and the second initial prediction layer is invoked, and a local similarity between the candidate image and the image-text composition sample is predicted based on the local sample feature and the word feature, to obtain the third local similarity corresponding to the candidate image.

In some embodiments, the operation of determining a composition sample feature of the image-text composition sample with reference to the reference image feature and the modification text feature may be implemented in the following manners: the reference image feature is added to the modification text feature, to obtain a sum feature; and the sum feature is divided by a norm of the sum feature, to obtain the composition sample feature of the image-text composition sample.

In some embodiments, the operation of invoking the first initial prediction layer, and predicting an overall similarity between the candidate image and the image-text composition sample based on the candidate image feature and the composition sample feature, to obtain the third global similarity corresponding to the candidate image may be implemented in the following manners: a transposition of the composition sample feature is multiplied by the candidate image feature, to obtain a sixth reference feature; and the first initial prediction layer is invoked, and the overall similarity between the candidate image and the image-text composition sample is predicted based on the sixth reference feature, to obtain the third global similarity corresponding to the candidate image.

In some embodiments, the operation of invoking the second initial prediction layer, and predicting a local similarity between the candidate image and the image-text composition sample based on the local sample feature and the word feature, to obtain the third local similarity corresponding to the candidate image may be implemented in the following manner: a transposition of each word feature is multiplied by the candidate image feature, to obtain a reference word feature corresponding to each word feature, and summation is performed on each reference word feature, to obtain a seventh reference feature; a transposition of each local sample feature is multiplied by the candidate image feature, to obtain a reference local sample feature corresponding to each local sample feature; summation is performed on the reference local sample feature, to obtain an eighth reference feature; and the second initial prediction layer is invoked, and the local similarity between the candidate image and the image-text composition sample is predicted based on the eighth reference feature, to obtain the third local similarity corresponding to the candidate image.

In some embodiments, the fourth similarity includes a fourth global similarity and a fourth local similarity, and the second initial prediction network includes a third initial prediction layer and a fourth initial prediction layer.

In some embodiments, the fourth global similarity is configured to indicate an overall similarity between the candidate image and the modification text sample. The fourth local similarity is configured to indicate a local similarity between the candidate image and the modification text sample. The third initial prediction layer is configured to predict the overall similarity between the candidate image and the modification text sample. The fourth initial prediction layer is configured to predict the local similarity between the candidate image and the modification text sample.

In some embodiments, the operation of invoking the second initial prediction layer, and predicting a local similarity between the candidate image and the image-text composition sample based on the local sample feature and the word feature, to obtain the third local similarity corresponding to the candidate image may be implemented in the following manner: a transposition of each word feature is multiplied by the candidate image feature, to obtain a reference word feature corresponding to each word feature, and summation is performed on each reference word feature, to obtain a ninth reference feature; and the second initial prediction layer is invoked, and the local similarity between the candidate image and the image-text composition sample is predicted based on the ninth reference feature, to obtain the third local similarity corresponding to the candidate image.

In some embodiments, because the candidate images include the target image sample, the third similarities of the candidate images and the fourth similarities of the candidate images include the third similarity and the fourth similarity of the target image sample. Because the target image sample is a candidate image having the highest similarity in the candidate images, the third similarity and the fourth similarity of the target image sample may be taken as a training label to train the initial image retrieval model. In this way, the obtained image retrieval model can effectively learn a feature representation of the target image sample, and can accurately identify the corresponding target image from a huge quantity of candidate images. Therefore, retrieval performance of the image retrieval model is effectively improved.

In some embodiments, the operation of training the initial image retrieval model with reference to the third similarity and the fourth similarity, to obtain the image retrieval model may be implemented in the following manner: a first loss value of the initial image retrieval model is determined based on the third similarity corresponding to the target image sample and the third similarity corresponding to each candidate image; a second loss value of the initial image retrieval model is determined based on the fourth similarity corresponding to the target image sample and the fourth similarity corresponding to each candidate image; and weighted summation is performed on the first loss value and the second loss value, to obtain a target loss value, and the initial image retrieval model is trained based on the target loss value, to obtain the image retrieval model.

As an example, an expression of the target loss value is:

$$L = {L}_{1} + α {L}_{2} \qquad ( 1 )$$

where L indicates the target loss value, L₁ indicates the first loss value, L₂ indicates the second loss value, and α indicates a weight for weighted summation.

In some embodiments, the third similarity includes a third global similarity and a third local similarity. The third global similarity is configured to indicate an overall similarity between the candidate image and the image-text composition sample, and the third local similarity is configured to indicate a local similarity between the candidate image and the image-text composition sample.

In some embodiments, the operation of determining a first loss value of the initial image retrieval model based on the third similarity corresponding to the target image sample and the third similarity corresponding to each candidate image may be implemented in the following manner: summation is performed on the third global similarity corresponding to each candidate image, to obtain a first summation result, and summation is performed on the third local similarity corresponding to each candidate image, to obtain a second summation result; the third global similarity corresponding to the target image sample is divided by the first summation result, to obtain a third loss value; the third local similarity corresponding to the target image sample is divided by the second summation result, to obtain a fourth loss value; and summation is performed on the third loss value and the fourth loss value, to obtain the first loss value.

As an example, an expression of the third loss value is:

$${L}_{3} = {\sum }_{i = 1}^{N} \frac{exp ( g - {s}_{ii}^{c 2 t} / τ )}{{\sum }_{j = 1}^{N} exp ( g - {s}_{ij}^{c 2 t} / τ )} \qquad ( 2 )$$

where L₃ indicates the third loss value,

$$exp ( g - {s}_{ii}^{c 2 t} / τ )$$

indicates the third global similarity corresponding to the target image sample,

$${\sum }_{j = 1}^{N} exp ( g - {s}_{ij}^{c 2 t} / τ )$$

indicates the first summation result, and N indicates a quantity of target image samples.

As an example, an expression of the fourth loss value is:

$${L}_{4} = {\sum }_{i = 1}^{N} \frac{exp ( 1 - {s}_{ii}^{c 2 t} / τ )}{{\sum }_{j = 1}^{N} exp ( 1 - {s}_{ij}^{c 2 t} / τ )} \qquad ( 3 )$$

where L₄ indicates the fourth loss value,

$$exp ( 1 - {s}_{ii}^{c 2 t} / τ )$$

indicates the third global similarity corresponding to the target image sample,

$${\sum }_{j = 1}^{N} exp ( 1 - {s}_{ij}^{c 2 t} / τ )$$

indicates the second summation result, and N indicates the quantity of target image samples.

As an example, an expression of the first loss value is:

$${L}_{1} = {L}_{3} + {L}_{4} = {\sum }_{i = 1}^{N} \frac{exp ( g - {s}_{ii}^{c 2 t} / τ )}{{\sum }_{j = 1}^{N} exp ( g - {s}_{ij}^{c 2 t} / τ )} + {\sum }_{i = 1}^{N} \frac{exp ( 1 - {s}_{ii}^{c 2 t} / τ )}{{\sum }_{j = 1}^{N} exp ( 1 - {s}_{ij}^{c 2 t} / τ )} \qquad ( 4 )$$

where L₁ indicates the first loss value, L₃ indicates the third loss value,

$$exp ( g - {s}_{ii}^{c 2 t} / τ )$$

indicates the third global similarity corresponding to the target image sample,

$${\sum }_{j = 1}^{N} exp ( g - {s}_{i j}^{c 2 t} / τ )$$

indicates the first summation result, L₄ indicates the fourth loss value,

$$exp ( l - {s}_{i i}^{c 2 t} / τ )$$

indicates the third global similarity corresponding to the target image sample,

$${\sum }_{j = 1}^{N} exp ( l - {s}_{i j}^{c 2 t} / τ )$$

indicates the second summation result, and N indicates the quantity of target image samples.

In some embodiments, the fourth similarity includes a fourth global similarity and a fourth local similarity. The fourth global similarity is configured to indicate an overall similarity between the candidate image and the modification text sample, and the fourth local similarity is configured to indicate a local similarity between the candidate image and the modification text sample.

In some embodiments, the operation of determining a second loss value of the initial image retrieval model based on the fourth similarity corresponding to the target image sample and the fourth similarity corresponding to each candidate image may be implemented in the following manner: summation is performed on the fourth global similarity corresponding to each candidate image, to obtain a third summation result, and summation is performed on the fourth local similarity corresponding to each candidate image, to obtain a fourth summation result; the fourth global similarity corresponding to the target image sample is divided by the third summation result, to obtain a fifth loss value; the fourth local similarity corresponding to the target image sample is divided by the fourth summation result, to obtain a sixth loss value; and summation is performed on the fifth loss value and the sixth loss value, to obtain the second loss value.

As an example, an expression of the fifth loss value is:

$${L}_{5} = {\sum }_{i = 1}^{N} \frac{exp ( g - {s}_{i i}^{c 2 t} / τ )}{{\sum }_{j = 1}^{N} exp ( g - {s}_{i j}^{c 2 t} / τ )} \qquad ( 5 )$$

where L₅ indicates the fifth loss value,

$$exp ( g - {s}_{i i}^{c 2 t} / τ )$$

indicates the fourth global similarity corresponding to the target image sample,

$${\sum }_{j = 1}^{N} exp ( g - {s}_{i j}^{c 2 t} / τ )$$

indicates the third summation result, and N indicates the quantity of target image samples.

As an example, an expression of the sixth loss value is:

$${L}_{6} = {\sum }_{i = 1}^{N} \frac{exp ( l - {s}_{i i}^{c 2 t} / τ )}{{\sum }_{j = 1}^{N} exp ( l - {s}_{i j}^{c 2 t} / τ )} \qquad ( 6 )$$

where L₆ indicates the sixth loss value,

$$exp ( l - {s}_{i i}^{c 2 t} / τ )$$

indicates the fourth local similarity corresponding to the target image sample,

$${\sum }_{j = 1}^{N} exp ( l - {s}_{i j}^{c 2 t} / τ )$$

indicates the fourth summation result, and N indicates the quantity of target image samples.

As an example, an expression of the second loss value is:

$${L}_{2} = {L}_{5} + {L}_{6} = {\sum }_{i = 1}^{N} \frac{exp ( g - {s}_{i i}^{c 2 t} / τ )}{{\sum }_{j = 1}^{N} exp ( g - {s}_{i j}^{c 2 t} / τ )} + {\sum }_{i = 1}^{N} \frac{exp ( l - {s}_{i i}^{c 2 t} / τ )}{{\sum }_{j = 1}^{N} exp ( l - {s}_{i j}^{c 2 t} / τ )} \qquad ( 7 )$$

where L₂ indicates the second loss value, L₅ indicates the fifth loss value, L₆ indicates the sixth loss value,

$$exp ( g - {s}_{i i}^{c 2 t} / τ )$$

indicates the fourth global similarity corresponding to the target image sample,

$${\sum }_{j = 1}^{N} exp ( g - {s}_{i j}^{c 2 t} / τ )$$

indicates the third summation result, N indicates the quantity of target image samples,

$$exp ( l - {s}_{i i}^{c 2 t} / τ )$$

indicates the fourth local similarity corresponding to the target image sample, and

$${\sum }_{j = 1}^{N} exp ( l - {s}_{i j}^{c 2 t} / τ )$$

indicates the fourth summation result.

In this way, the first loss value of the initial image retrieval model is determined based on the third similarity corresponding to the target image sample and the third similarity corresponding to each candidate image; the second loss value of the initial image retrieval model is determined based on the fourth similarity corresponding to the target image sample and the fourth similarity corresponding to each candidate image; and weighted summation is performed on the first loss value and the second loss value, to obtain the target loss value, and the initial image retrieval model is trained based on the target loss value, to obtain the image retrieval model. Because the image retrieval model obtained through training fully utilizes the third similarity corresponding to the target image sample and the third similarity corresponding to each candidate image, retrieval performance of the image retrieval model is effectively improved.

Operation 1042: Perform feature extraction on a reference image and modification text, respectively, to obtain a reference image feature of the reference image and a modification text feature of the modification text, and determine a composition feature of an image-text composition with reference to the reference image feature and the modification text feature.

In some embodiments, the operation of performing feature extraction on a reference image and modification text, to obtain a reference image feature of a reference image and a modification text feature of the modification text may be implemented in the following manner: an image encoding model is invoked, feature extraction is performed on the reference image, to obtain the reference image feature of the reference image; and a text encoding model is invoked, and feature extraction is performed on the modification text, to obtain the modification text feature of the modification text.

In some embodiments, the image encoding model and the text encoding model may both be machine learning models. The image encoding model is obtained by training the machine learning model based on an image sample, and the text encoding model may be obtained by training the machine learning model based on a text sample.

In some embodiments, the operation of determining a composition feature of the image-text composition with reference to the reference image feature and the modification text feature may be implemented in the following manners: the reference image feature is added to the modification text feature, to obtain a sum feature; and the sum feature is divided by a norm of the sum feature, to obtain the composition feature of the image-text composition.

As an example, an expression of the composition feature of the image-text composition is:

$${T}_{1} = \frac{{\overline{v}}_{i}^{r} + {a}_{i ( K + 1 )}^{m}}{{‖ {\overline{v}}_{i}^{r} + {a}_{i ( K + 1 )}^{m} ‖}_{2}} \qquad ( 8 )$$

where T₁ indicates the composition feature of the image-text composition,

$${\overline{v}}_{i}^{r} + {a}_{i ( K + 1 )}^{m}$$

indicates the sum feature, and

$${‖ {\overline{v}}_{i}^{r} + {a}_{i ( K + 1 )}^{m} ‖}_{2}$$

indicates the norm of the sum feature.

In some embodiments, operation 1043 to operation 1045 may be performed for each candidate image. The following further describes operation 1043 to operation 1045.

Operation 1043: Perform feature extraction on the candidate image, to obtain a candidate image feature of the candidate image.

In some embodiments, operation 1043 may be implemented in the following manner: the image encoding model is invoked, and feature extraction is performed on the candidate image, to obtain the candidate image feature of the candidate image.

Operation 1044: Invoke a first prediction network, predict a similarity between a candidate image and the image-text composition based on a candidate image feature and the composition feature, to obtain a first similarity corresponding to the candidate image.

In some embodiments, the first similarity includes a first global similarity and a first local similarity, and the first prediction network includes a first prediction layer and a second prediction layer. The first global similarity is configured to indicate an overall similarity between the candidate image and the image-text composition. The first local similarity is configured to indicate a local similarity between the candidate image and the image-text composition. The first prediction layer is configured to predict the overall similarity between the candidate image and the image-text composition. The second prediction layer is configured to predict the local similarity between the candidate image and the image-text composition.

In some embodiments, operation 1044 may be implemented in the following manner: the first prediction layer is invoked, and the overall similarity between the candidate image and the image-text composition is predicted based on the candidate image feature and the composition feature, to obtain the first global similarity corresponding to the candidate image; feature segmentation is performed on the composition feature, to obtain a plurality of local features corresponding to the composition feature, and feature segmentation is performed on the modification text feature, to obtain a word feature corresponding to each word in the modification text; and the second prediction layer is invoked, and the local similarity between the candidate image and the image-text composition is predicted based on the local feature and the word feature, to obtain the first local similarity corresponding to the candidate image.

Refer to FIG. 8. As an example, FIG. 8 is a schematic diagram of a principle of a first prediction network according to an embodiment of the present disclosure. A first prediction layer 85 is invoked, and the overall similarity between the candidate image and the image-text composition is predicted based on a candidate image feature 81 and a composition feature 82, to obtain a first global similarity 87 corresponding to the candidate image. A second prediction layer 86 is invoked, and the local similarity between the candidate image and the image-text composition is predicted based on a local feature 83 and a word feature 84, to obtain a first local similarity 88 corresponding to the candidate image.

In some embodiments, the operation of invoking the first prediction layer, and predicting the overall similarity between the candidate image and the image-text composition based on the candidate image feature and the composition feature, to obtain the first global similarity corresponding to the candidate image may be implemented in the following manner: a transposition of the composition feature is multiplied by the candidate image feature, to obtain a first reference feature; and the first prediction layer is invoked, and the overall similarity between the candidate image and the image-text composition is predicted based on the first reference feature, to obtain the first global similarity corresponding to the candidate image.

As an example, an expression of the first reference feature is:

$${T}_{2} = {T}_{1} {\overline{v}}_{j}^{t} = \frac{{\overline{v}}_{i}^{r} + {a}_{i ( K + 1 )}^{m}}{{‖ {\overline{v}}_{i}^{r} + {a}_{i ( K + 1 )}^{m} ‖}_{2}} {\overline{v}}_{j}^{t} \qquad ( 9 )$$

where T₂ indicates the first reference feature, T₁ indicates the composition feature, v̅ⱼ^{t} indicates the candidate image feature,

$${\overline{v}}_{i}^{r} + {a}_{i ( K + 1 )}^{m}$$

indicates the sum feature, and

$${‖ {\overline{v}}_{i}^{r} + {a}_{i ( K + 1 )}^{m} ‖}_{2}$$

indicates the norm of the sum feature.

In some embodiments, the operation of invoking the second prediction layer, and predicting the local similarity between the candidate image and the image-text composition based on the local feature and the word feature, to obtain the first local similarity corresponding to the candidate image may be implemented in the following manner: a transposition of each word feature is multiplied by the candidate image feature, to obtain a reference word feature corresponding to each word feature, and summation is performed on each reference word feature, to obtain a second reference feature; a transposition of each local feature is multiplied by the candidate image feature, to obtain a reference local feature corresponding to each local feature, and summation is performed on each reference local feature, to obtain a third reference feature; summation is performed on the second reference feature and the third reference feature, to obtain a fourth reference feature; and the second prediction layer is invoked, and the local similarity between the candidate image and the image-text composition is predicted based on the fourth reference feature, to obtain the first local similarity corresponding to the candidate image.

As an example, an expression of the fourth reference feature is:

$${T}_{3} = {\sum }_{k = 0}^{M} {b}_{ikj}^{v 2 t} + {\sum }_{l = 0}^{K + 1} {b}_{ilj}^{m 2 t} \qquad ( 10 )$$

where T₃ indicates the fourth reference feature,

$${\sum }_{k = 0}^{M} {b}_{ikj}^{v 2 t}$$

indicates the second reference feature,

$${\sum }_{l = 0}^{K + 1} {b}_{ilj}^{m 2 t}$$

indicates the third reference feature,

$${b}_{ilj}^{m 2 t}$$

indicates the reference local feature, and

$${b}_{ikj}^{v 2 t}$$

indicates the reference word feature.

Operation 1045: Invoke a second prediction network, and predict a similarity between the candidate image and the modification text based on the candidate image feature and the modification text feature, to obtain a second similarity corresponding to the candidate image.

In some embodiments, the second similarity includes a second global similarity and a second local similarity, and the second prediction network includes a third prediction layer and a fourth prediction layer.

In some embodiments, the second global similarity is configured to indicate an overall similarity between the candidate image and the modification text, and the second local similarity is configured to indicate a local similarity between the candidate image and the modification text. The third prediction layer is configured to predict the overall similarity between the candidate image and the modification text. The fourth prediction layer is configured to predict the local similarity between the candidate image and the modification text.

In some embodiments, operation 1045 may be implemented in the following manner: the third prediction layer is invoked, and the overall similarity between the candidate image and the modification text is predicted based on the candidate image feature and the modification text feature, to obtain the second global similarity corresponding to the candidate image; feature segmentation is performed on the modification text feature, to obtain a word feature corresponding to each word in the modification text; and the fourth prediction layer is invoked, and the local similarity between the candidate image and the modification text is predicted based on the word feature and the candidate image feature, to obtain the second local similarity corresponding to the candidate image.

In some embodiments, the operation of invoking the third prediction layer, and predicting the overall similarity between the candidate image and the modification text based on the candidate image feature and the modification text feature, to obtain the second global similarity corresponding to the candidate image may be implemented in the following manner: a transposition of the modification text feature is multiplied by the candidate image feature, to obtain a fifth reference feature; and the third prediction layer is invoked, and the overall similarity between the candidate image and the modification text is predicted based on the fifth reference feature, to obtain the second global similarity corresponding to the candidate image.

As an example, an expression of the second global similarity is:

$$g - {s}_{ij}^{m 2 t} = {( {a}_{i ( K + 1 )}^{m} )}^{T} {\overline{v}}_{j}^{t} \qquad ( 11 )$$

where

$$g - {s}_{ij}^{m 2 t}$$

indicates the second global similarity,

$${a}_{i ( K + 1 )}^{m}$$

indicates the modification text feature, and v̅ⱼ^{t} indicates the candidate image feature.

In some embodiments, the operation of invoking the fourth prediction layer, and predicting the local similarity between the candidate image and the modification text based on the word feature and the candidate image feature, to obtain the second local similarity corresponding to the candidate image may be implemented in the following manner: a transposition of each word feature is multiplied by the candidate image feature, to obtain a reference word feature corresponding to each word feature, and summation is performed on each reference word feature, to obtain a sixth reference feature; and the fourth prediction layer is invoked, and the local similarity between the candidate image and the modification text is predicted based on the sixth reference feature, to obtain the second local similarity corresponding to the candidate image.

As an example, an expression of the second local similarity is:

$$l - {s}_{ij}^{m 2 t} = \frac{1}{K + 2} {\sum }_{l = 0}^{K + 1} {b}_{ilj}^{m 2 t} \qquad ( 12 )$$

where

$$l - {s}_{ij}^{m 2 t}$$

indicates the second local similarity,

$${b}_{ilj}^{m 2 t}$$

indicate the second reference feature, and K indicates a quantity of word features.

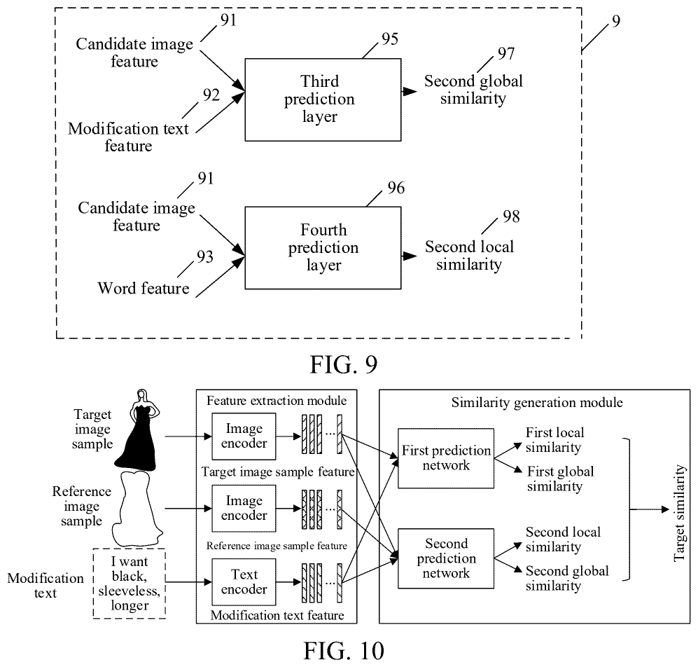

Refer to FIG. 9. As an example, FIG. 9 is a schematic diagram of a principle of a second prediction network according to an embodiment of the present disclosure. A third prediction layer 95 is invoked, and the overall similarity between the candidate image and modification text is predicted based on a candidate image feature 91 and a modification text feature 92, to obtain a second global similarity 97 corresponding to the candidate image. Feature segmentation is performed on the modification text feature 92, to obtain a word feature 93 corresponding to each word in the modification text. A fourth prediction layer 96 is invoked, and the local similarity between the candidate image and the modification text is predicted based on the word feature 93 and the candidate image feature 91, to obtain a second local similarity 98 corresponding to the candidate image.

In some embodiments, the operation of invoking the fourth prediction layer, and predicting the local similarity between the candidate image and the modification text based on the word feature and the candidate image feature, to obtain the second local similarity corresponding to the candidate image may be implemented in the following manner: a transposition of the word feature is multiplied by the candidate image feature, to obtain a second reference feature; and the fourth prediction layer is invoked, and the local similarity between the candidate image and the modification text is predicted based on the second reference feature, to obtain the second local similarity corresponding to the candidate image.

In this way, the third prediction layer is invoked, and the overall similarity between the candidate image and the modification text is predicted based on the candidate image feature and the modification text feature, to obtain the second global similarity corresponding to the candidate image; feature segmentation is performed on the modification text feature, to obtain the word feature corresponding to each word in the modification text; and the fourth prediction layer is invoked, and the local similarity between the candidate image and the modification text is predicted based on the word feature and the candidate image feature, to obtain the second local similarity corresponding to the candidate image. In this way, the second similarity is effectively determined from two different dimensions, namely, a global dimension and a local dimension, based on the determined second global similarity and second local similarity. Therefore, validity of the determined second similarity is effectively improved.

Operation 105: Determine at least one target image satisfying the image retrieval condition from the plurality of candidate images with reference to the first similarity and the second similarity.

In some embodiments, the target image satisfying the image retrieval condition is a candidate image that is in the plurality of candidate images and that satisfies the modification expectation corresponding to the modification text.

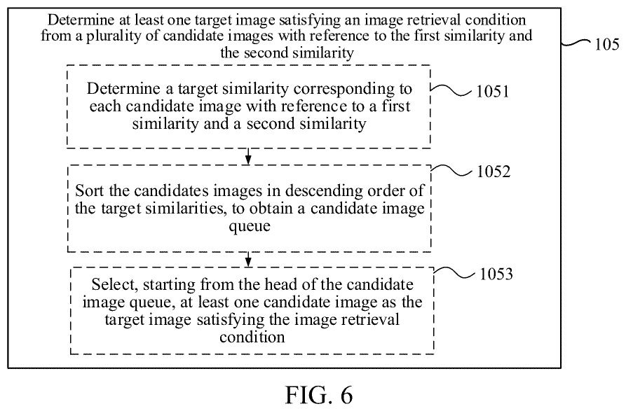

Refer to FIG. 6. In some embodiments, FIG. 6 is a fourth schematic flowchart of an image retrieval method according to an embodiment of the present disclosure. Operation 105 shown in FIG. 3 may be implemented through operation 1051 to operation 1053 shown in FIG. 6.

Operation 1051: Determine a target similarity corresponding to each candidate image with reference to the first similarity and the second similarity.

In some embodiments, the first similarity includes a first global similarity configured to indicate an overall similarity between the candidate image and the image-text composition, and a first local similarity configured to indicate a local similarity between the candidate image and the image-text composition. The second similarity includes a second global similarity configured to indicate an overall similarity between the candidate image and the modification text, and a second local similarity configured to indicate a local similarity between the candidate image and the modification text.

In some embodiments, operation 1051 may be implemented in the following manner: for each candidate image, the following processing is performed: a product of the first global similarity and the second global similarity is determined as a first target similarity; a product of the first local similarity and the second local similarity is determined as a second target similarity; and a sum of the first target similarity, the second target similarity, and the first local similarity is determined as the target similarity corresponding to the candidate image.

As an example, an expression of the first target similarity is:

$$g - {s}_{i j}^{f} = g - {s}_{i j}^{m 2 t} \times g - {s}_{i j}^{c 2 t} \qquad ( 13 )$$

where

$$g - {s}_{i j}^{f}$$

indicates the first target similarity,

$$g - {s}_{i j}^{m 2 t}$$

indicates the first global similarity, and

$$g - {s}_{i j}^{c 2 t}$$

indicates the second global similarity.

As an example, an expression of the second target similarity is:

$$l - {s}_{i j}^{f} = l - {s}_{i j}^{m 2 t} \times l - {s}_{i j}^{c 2 t} \qquad ( 14 )$$

where

$$l - {s}_{i j}^{f}$$

indicates the second target similarity,

$$l - {s}_{i j}^{m 2 t}$$

indicates the second local similarity, and

$$l - {s}_{i j}^{c 2 t}$$

indicates the first local similarity.

As an example, an expression of the target similarity is:

$${s}_{ij} = l - {s}_{ij}^{c 2 t} + g - {s}_{ij}^{f} + g - {s}_{ij}^{f} \qquad ( 15 )$$

where sᵢⱼ indicates the target similarity,

$$g - {s}_{ij}^{f}$$

indicates the first target similarity,

$$l - {s}_{i j}^{f}$$

indicates the second target similarity, and

$$l - {s}_{ij}^{c 2 t}$$

indicates the first local similarity.

Operation 1052: Sort the candidate images in descending order of the target similarities, to obtain a candidate image queue.

As an example, the candidate images include a candidate image A, a candidate image B, and a candidate image C. A target similarity corresponding to the candidate image A is 0.8, a target similarity corresponding to the candidate image B is 0.9, and a target similarity corresponding to the candidate image C is 1. The candidate images are sorted in descending order of the target similarities, to obtain a candidate image queue {the candidate image C, the candidate image B, and the candidate image A}.

Operation 1053: Select, starting from the head of the candidate image queue, at least one candidate image as the target image satisfying the image retrieval condition.

Continuing with the above example, starting from the head of the candidate image queue {the candidate image C, the candidate image B, and the candidate image A}, the candidate image C is selected as the target image satisfying the image retrieval condition.

Continuing with the above example, starting from the head of the candidate image queue {the candidate image C, the candidate image B, and the candidate image A}, the candidate image C and the candidate image B are selected as the target images satisfying the image retrieval condition.

In some embodiments, after operation 105, the target image may be displayed in the following manner: the at least one target image is transmitted to the terminal, and the terminal displays the at least one target image.

In some embodiments, after displaying the at least one target image, the terminal determines a selected target image as a first target image in response to a selection operation for the at least one target image, and determines an unselected target image as a second target image. The terminal cancels displaying the second target image and continues displaying the first target image.

In this way, the image retrieval condition including the reference image and the modification text and the plurality of candidate images are acquired, the first similarity between each candidate image and the image-text composition and the second similarity between each candidate image and the modification text are determined, and the target image satisfying the image retrieval condition is determined from the plurality of candidate images with reference to the first similarity and the second similarity. In this way, the retrieved target image satisfying the image retrieval condition is determined based on the first similarity between the candidate image and the image-text composition, which can effectively ensure that the determined target image can meet retrieval requirements of both the reference image and the modification text. In addition, the target image is also determined based on the second similarity between the candidate image and the modification text, which can enhance the impact of the modification expectation of the modification text on the determined target image. Therefore, the target image can highly satisfy the modification expectation of the modification text, and accuracy of image retrieval is effectively improved.

The following describes exemplary application of the embodiments of the present disclosure in an actual application scenario.

In recent years, with the rapid development of the Internet, multimedia data explosively grows in a plurality of forms such as text, an image, and audio, and various same or similar objects emerge one by one. Multimedia retrieval has become a basic task for users to flexibly acquire information. Therefore, to meet increasingly complex retrieval requirements of users, LVCQ-IR is put forward and attracts increasing attention. As one of the most popular multimedia retrieval models nowadays, LVCQ-IR aims to take a reference image and a piece of expected modification text of the image as query input, and retrieve a corresponding target image through database query. Because the input text expresses an intention of modifying the reference image, an existing retrieval model applied to LVCQ-IR mainly focuses on designing a synthetic network, that is, a feature representation of the reference image and a feature representation of intention text are fused into a composed query representation, and the composed query representation is made to be as close to a feature representation of the target image as possible through model training.

However, in a model design process, the fused composed query representation will be affected by the reference image to a large extent, whereby some or even all information in the intention text is ignored. For example, if a non-target image A is very similar to a reference image B used during training, A is not matched with a description in the intention text, and a real target image C is matched with the description in the intention text, the following situation may occur during model training: the fused composed query representation is increasingly close to a feature representation of A, rather than close to a representation of the real target image C, which results in an incorrect retrieval result.

Because the target image is matched with semantic information included in the modification text, a similarity between the target image and the text is very high. The existing LVCQ-IR model neglects this sign. To resolve the problem, the embodiments of the present disclosure provide an image retrieval method. In a training process, a model is optimized by using two loss functions, whereby a learning feature of a composed query is close to a learning feature of a target image, and a feature of the modification text is similar to a feature of the target image, that is, an effect of content of the modification text on model optimization is enhanced. Finally, at an inference stage, a similarity between the modification text and a candidate image is taken as a filter, which is fused into a similarity relationship between the composed query and the candidate image, to obtain a final similarity result for target image retrieval.

Currently, it is difficult to meet a retrieval intention requirement of a user by using an image to query an image, and using a composition of text and an image to query an image can further satisfy a retrieval intention of the user, and recall an accurate image. However, in the face of large-scale complex data in an actual scenario, a text-image composed query still faces a big challenge in retrieval precision. Therefore, how to effectively ensure retrieval precision of a text-image composed query has high research significance and landing value.

Refer to FIG. 10. In some embodiments, FIG. 10 is a schematic diagram of a principle of an image retrieval method according to an embodiment of the present disclosure. The image retrieval method provided in the embodiments of the present disclosure may be implemented by using two major submodules, namely, a feature extraction module and a similarity generation module. The feature extraction module is configured to respectively convert feature representations of a reference image sample, modification text, and a target image sample into a set of feature sequences, which may be further subdivided into an image encoder and a text encoder according to different forms of to-be-processed information, and are designed based on a CLIP model. The similarity generation module innovatively considers similarity relationships between the target image and the reference image as well as the modification text, and not only designs a common similarity

$${s}_{ij}^{c 2 t}$$

between a composed query feature

$$( {x}_{i}^{r} , {t}_{i}^{m} )$$

and a target image feature

$$( {x}_{j}^{t} ) ,$$

but also calculates an individual similarity

$${s}_{i j}^{m 2 t}$$

between a modification text feature

$${t}_{i}^{m}$$

and the target image feature

$$( {x}_{j}^{t} ) .$$

Therefore, based on the basic feature that “because the target image includes semantic information of the modification text, a similarity between the modification text and the target image is relatively high”, an m2t similarity is taken as a filter to screen and filter a false target image, which improves retrieval performance.

Refer to FIG. 10. In some embodiments, for the image encoder, the image encoder adopts the same structure as 12-layer ViT in CLIP, and aims to process the reference image sample and the target image sample into a set of visual feature sequences (namely, a reference image sample feature corresponding to the reference image sample, and a target image sample feature corresponding to the target image sample). For an input image x*ᵢ∈R^{3×H×W}, H×W representing a resolution of the image, the encoder first segments x*ᵢ into M sub-segments, and then converts all sub-segments into a set of feature sequences, namely,

$${F}_{i}^{*} = {\{ {f}_{i j}^{*} \}}_{j = 1}^{M} .$$

### Before,

$${F}_{i}^{*}$$

is inputted in Transformer, a learnable signature feature [CLS] is added to an original feature sequence, which facilitates better learning of a feature representation. Finally, after processing by Transformer, a feature sequence representation of the image feature is generated, namely,

$${V}_{i}^{*} = {\{ {v}_{i j}^{*} \}}_{j = 0}^{M} .$$

In addition, to facilitate subsequent similarity calculation, all feature sequence representations are subjected to l₂ normalization, namely,

$${v}_{i j}^{*} = \frac{{v}_{i j}^{*}}{{‖ {v}_{i j}^{*} ‖}_{2}} .$$

Refer to FIG. 10. In some embodiments, for the text encoder, the text encoder also utilizes a structure in the CLIP model and adopts a similar processing policy, that is, first marks a text input

$${t}_{i}^{m}$$

as a set of featurization sequences (namely, the modification text feature corresponding to the modification text), and inputs the set of featurization sequences into a transform stack. Finally, after processing, a feature form of the input text (the modification text shown in FIG. 10) may be represented as

$${A}_{i}^{m} = {\{ {a}_{i j}^{m} \}}_{j = 0}^{K + 1} ,$$

where, K represents a total quantity of words in the input text,

$${a}_{ij}^{m} ,$$

j∈{1, 2, . . . , K} represents a feature representation of a j^{th} word in the input text, and

$${a}_{i 0}^{m} and {a}_{i ( K + 1 )}^{m}$$

respectively represent representation forms of two types of special features in the CLIP model, namely, [SOS] and [EOS]. Finally, similar to the above processing, all text feature sequences are subjected to l₂ normalization, namely,

$${a}_{i j}^{m} = \frac{{a}_{i j}^{m}}{{‖ {a}_{i j}^{m} ‖}_{2}} .$$

In some embodiments, for a first prediction network in the similarity generation module, during previous optimization of the c2t similarity, the model expects that for each j≠i, the similarity

$${s}_{i i}^{c 2 t}$$

is higher than

$${s}_{i j}^{c 2 t} .$$

Finally, at the inference stage, for the composed query (x^{r} (reference image), t^{m} (modification text)), the target image x^{t} is returned. Therefore, the c2t similarity between x^{t} and (x^{r}, t^{m}) is the highest. However, as described above, the similarity is significantly affected by x^{r}, which results in an incorrect result. Therefore, in the embodiments of the present disclosure, in addition to the c2t similarity, the similarity

$${s}_{ij}^{m 2 t} ,$$

namely, the m2t similarity, between the modification text feature

$${t}_{i}^{m}$$

and the target image feature

$$( {x}_{j}^{t} )$$

is further calculated.

Refer to FIG. 10. In some embodiments, for the first prediction network in the similarity generation module, the same structure as CLVC-Net is adopted, and for given composed query

$$( {x}_{i}^{r} , {t}_{i}^{m} )$$

and candidate images

$${x}_{j}^{t} ,$$

similarities are respectively calculated from a global perspective and a local perspective, and are denoted as

$$g - {s}_{ij}^{c 2 t}$$

(a first grobal similarity) and

$$l - {s}_{ij}^{c 2 t}$$

(a first local similarity). A global c2t similarity, namely,

$$g - {s}_{ij}^{c 2 t} ,$$

is defined as a cosine similarity between a global feature of the composed query and a global feature of the candidate image, and is denoted as:

$$g - {s}_{ij}^{c 2 t} = {( \frac{{\overline{v}}_{i}^{r} + {a}_{i ( K + 1 )}^{m}}{{‖ {\overline{v}}_{i}^{r} + {a}_{i ( K + 1 )}^{m} ‖}_{2}} )}^{T} {\overline{v}}_{j}^{t} \qquad ( 16 )$$

where

$${\overline{v}}_{i}^{*}$$

represents a global feature of an image x* subjected to l₂ normalization,

$${a}_{i ( K + 1 )}^{m} ,$$

namely, an [EOS] feature, represents a global feature of modification text

$${t}_{i}^{m} ,$$

a sum of the two represents a global feature of an entire composed query

$$( {x}_{i}^{r} , {t}_{i}^{m} ) , and {\overline{v}}_{j}^{t}$$

is a global feature of a candidate image

$${x}_{j}^{t} .$$

In addition, to calculate a local similarity, in an experiment, a similarity between a local feature of the composed query and the candidate image

$${x}_{j}^{t}$$

is first defined, namely,

$${b}_{ikj}^{v 2 t} = {max ( {v}_{ik}^{r} )}^{T} {v}_{jz}^{t} and {b}_{ilj}^{m 2 t} = {max ( {v}_{il}^{m} )}^{T} {v}_{jz}^{t} .$$

Then, based on a similarity relationship between a single feature and the candidate image, a final local similarity

$$1 - {s}_{ij}^{c 2 t}$$

may be denoted as:

$$1 - {s}_{ij}^{c 2 t} = \frac{1}{M + K + 3} ( {\sum }_{k = 0}^{M} {b}_{ikj}^{v 2 t} + {\sum }_{l = 0}^{K + 1} {b}_{ilj}^{m 2 t} ) \qquad ( 17 )$$

where

$${v}_{ik}^{r}$$

is the local feature of the composed query,

$${a}_{il}^{m}$$

is a local feature of the modification text, M is a total quantity of local features of the candidate image, and K is the quantity of words in the modification text.

Refer to FIG. 10. In some embodiments, for a second prediction network in the similarity generation module, similar to the c2t similarity, in the embodiments of the present disclosure, the m2t similarity is also calculated from the two perspectives, namely, the global perspective and the local perspective, and is denoted as

$$g - {s}_{ij}^{m 2 t}$$

(a second global similarity) and

$$1 - {s}_{ij}^{m 2 t}$$

(a second local similarity). Because the m2t similarity only considers a similarity between the modification text and the target image, and does not involve the reference image, a calculation formula is simpler than that of the c2t similarity and is denoted as:

$$g - {s}_{ij}^{m 2 t} = {( {a}_{i ( K + 1 )}^{m} )}^{T} {\overline{v}}_{j}^{t} \qquad ( 18 )$$

$$1 - {s}_{ij}^{m 2 t} = \frac{1}{K + 2} {\sum }_{l = 0}^{K + 1} {b}_{ilj}^{m 2 t} \qquad ( 19 )$$

In some embodiments, for a loss function, to enable that for each j≠i, a c2t similarity of matched triples

$$( {x}_{i}^{r} , {t}_{i}^{m} , {x}_{i}^{t} )$$

is greater than that of unmatched triples

$$( {x}_{i}^{r} , {t}_{i}^{m} , {x}_{j}^{t} ) ,$$

an InfoNCE loss is selected herein as the loss function, to optimize the similarity relationship between the composed query and the target image, and is denoted as:

$${ℒ}_{c 2 t} = \frac{1}{N} {\sum }_{i = 1}^{N} \frac{exp ( g - {s}_{ii}^{c 2 t} / τ )}{{\sum }_{j = 1}^{N} exp ( g - {s}_{ij}^{c 2 t} / τ )} + \frac{1}{N} {\sum }_{i = 1}^{N} \frac{exp ( l - {s}_{ii}^{c 2 t} / τ )}{{\sum }_{j = 1}^{N} exp ( l - {s}_{ij}^{c 2 t} / τ )} \qquad ( 20 )$$

In addition, because the m2t similarity may be taken as a filter to further improve retrieval performance, the m2t similarity between

$${t}_{i}^{m} and {x}_{i}^{t}$$

is greater than that between

$${t}_{i}^{m} and {x}_{j}^{t} .$$

### That is,

$${x}_{j}^{t}$$

does not include semantic information described in

$${t}_{i}^{m} .$$

To achieve this objective, a comparative learning paradigm is adopted herein for processing, that is,

$${t}_{i}^{m}$$

is not similar to

$${x}_{i}^{t} ,$$

but is not similar to other candidate images. Based on this, the loss function may be denoted as:

$${ℒ}_{m 2 t} = \frac{1}{N} {\sum }_{i = 1}^{N} \frac{exp ( g - {s}_{ii}^{m 2 t} / τ )}{{\sum }_{j = 1}^{N} exp ( g - {s}_{ij}^{m 2 t} / τ )} + \frac{1}{N} {\sum }_{i = 1}^{N} \frac{exp ( l - {s}_{ii}^{m 2 t} / τ )}{{\sum }_{j = 1}^{N} exp ( l - {s}_{ij}^{m 2 t} / τ )} \qquad ( 21 )$$

Therefore, a final loss function in the Text2Target Filter model is denoted as:

$$ℒ = {ℒ}_{c 2 t} + α {ℒ}_{m 2 t} \qquad ( 22 )$$

In some embodiments, at the inference stage, in the embodiments of the present disclosure, first, the m2t similarity and the c2t similarity are fused, to construct filtered global and local combined queries, to obtain candidate image similarities, which are denoted as:

$$g - {s}_{ij}^{f} = g - {s}_{ij}^{m 2 t} * g - {s}_{ij}^{c 2 t} \qquad ( 23 )$$

$$l - {s}_{ij}^{f} = l - {s}_{ij}^{m 2 t} * l - {s}_{ij}^{c 2 t} \qquad ( 24 )$$

Therefore, for the input composed query

$$( {x}_{i}^{r} , {t}_{i}^{m} )$$

and the candidate image

$${x}_{i}^{t} ,$$

four different types of similarity relationships are generated in total: the global c2t similarity

$$g - {s}_{ij}^{c 2 t} ,$$

the local c2t similarity

$$l - {s}_{ij}^{c 2 t} ,$$

the filtered global c2t similarity

$$g - {s}_{ij}^{f} ,$$

and the filtered local c2t similarity

$$g - {s}_{ij}^{f} .$$

Then, after validation through experiment, a final similarity sᵢⱼ applied to retrieval may be denoted as:

$${s}_{ij} = l - {s}_{ij}^{c 2 t} + g - {s}_{ij}^{f} + g - {s}_{ij}^{f} \qquad ( 25 )$$

In the embodiments of the present disclosure, relevant data, such as the reference image and the modification text are involved. When the embodiments of the present disclosure are applied to specific products or technologies, user permission or consent is required, and collection, use, and processing of relevant data need to comply with relevant laws and regulations, and standards of relevant countries and regions.

The following continues to describe an exemplary structure of the image retrieval apparatus 455 provided in the embodiments of the present disclosure that is implemented as a software module. In some embodiments, as shown in FIG. 2, the software module in the image retrieval apparatus 455 stored in the memory 450 may include: an acquisition module 4551, configured to acquire an image retrieval condition, the image retrieval condition including a reference image and modification text, and the modification text being configured to indicate a modification expectation for the reference image; a composition module 4552, configured to compose the reference image and the modification text, to obtain an image-text composition; a similarity module 4553, configured to acquire a plurality of candidate images, and determine a first similarity between each candidate image and the image-text composition, and a second similarity between each candidate image and the modification text; and a retrieval module 4554, configured to determine at least one target image satisfying the image retrieval condition from the plurality of candidate images with reference to the first similarity and the second similarity.

In some embodiments, the similarity module 4553 is further configured to acquire an image retrieval model, the image retrieval model including a first prediction network and a second prediction network; perform feature extraction on the reference image and the modification text, respectively, to obtain a reference image feature of the reference image and a modification text feature of the modification text, and determine a composition feature of the image-text composition with reference to the reference image feature and the modification text feature; and for each candidate image, perform the following processing: perform image feature extraction on the candidate image to obtain a candidate image feature of the candidate image; invoke the first prediction network, and predict a similarity between the candidate image and the image-text composition based on the candidate image feature and the composition feature, to obtain the first similarity corresponding to the candidate image; and invoke the second prediction network, and predict a similarity between the candidate image and the modification text based on the candidate image feature and the modification text feature, to obtain the second similarity corresponding to the candidate image.

In some embodiments, the first similarity includes a first global similarity and a first local similarity, and the first prediction network includes a first prediction layer and a second prediction layer. The similarity module 4553 is further configured to invoke the first prediction layer, and predict an overall similarity between the candidate image and the image-text composition based on the candidate image feature and the composition feature, to obtain the first global similarity corresponding to the candidate image; perform feature segmentation on the composition feature, to obtain a plurality of local features corresponding to the composition feature, and perform feature segmentation on the modification text feature, to obtain a word feature corresponding to each word in the modification text; and invoke the second prediction layer, and predict a local similarity between the candidate image and the image-text composition based on the local feature and the word feature, to obtain the first local similarity corresponding to the candidate image.

In some embodiments, the similarity module 4553 is further configured to add the reference image feature to the modification text feature, to obtain a sum feature; and divide the sum feature by a norm of the sum feature, to obtain the composition feature of the image-text composition. The similarity module 4553 is further configured to multiply a transposition of the composition feature by the candidate image feature, to obtain a first reference feature; and invoke the first prediction layer, and predict the overall similarity between the candidate image and the image-text composition based on the first reference feature, to obtain the first global similarity corresponding to the candidate image.

In some embodiments, the similarity module 4553 is further configured to multiply a transposition of each word feature by the candidate image feature, to obtain a reference word feature corresponding to each word feature, and perform summation on each reference word feature, to obtain a second reference feature; multiply a transposition of each local feature by the candidate image feature, to obtain a reference local feature corresponding to each local feature, and perform summation on each reference local feature, to obtain a third reference feature; perform summation on the second reference feature and the third reference feature, to obtain a fourth reference feature; and invoke the second prediction layer, and predict the local similarity between the candidate image and the image-text composition based on the fourth reference feature, to obtain the first local similarity corresponding to the candidate image.

In some embodiments, the second similarity includes a second global similarity and a second local similarity, and the second prediction network includes a third prediction layer and a fourth prediction layer. The similarity module 4553 is further configured to invoke the third prediction layer, and predict an overall similarity between the candidate image and the modification text based on the candidate image feature and the modification text feature, to obtain the second global similarity corresponding to the candidate image; perform feature segmentation on the modification text feature, to obtain a word feature corresponding to each word in the modification text; and invoke the fourth prediction layer, and predict a local similarity between the candidate image and the modification text based on the word feature and the candidate image feature, to obtain the second local similarity corresponding to the candidate image.

In some embodiments, the similarity module 4553 is further configured to acquire an image retrieval condition sample and a target image sample, the image retrieval condition sample including a reference image sample and a modification text sample, the modification text sample being configured to indicate a modification expectation for the reference image sample, and the target image sample satisfying the modification expectation; compose the reference image sample and the modification text sample, to obtain an image-text composition sample; acquire a plurality of candidate images, the candidate images including the target image sample; for each candidate image, invoke an initial image retrieval model, and perform similarity prediction on the candidate image based on the candidate image, the reference image sample, and the modification text sample, to obtain a third similarity between the candidate image and the image-text composition sample, and a fourth similarity between the candidate image and the modification text sample; and train the initial image retrieval model with reference to the third similarity and the fourth similarity, to obtain the image retrieval model.

In some embodiments, the similarity module 4553 is further configured to determine a first loss value of the initial image retrieval model based on the third similarity corresponding to the target image sample and the third similarity corresponding to each candidate image; determine a second loss value of the initial image retrieval model based on the fourth similarity corresponding to the target image sample and the fourth similarity corresponding to each candidate image; and perform weighted summation on the first loss value and the second loss value, to obtain a target loss value, and train the initial image retrieval model based on the target loss value, to obtain the image retrieval model.

In some embodiments, the retrieval module 4554 is further configured to determine a target similarity corresponding to each candidate image with reference to the first similarity and the second similarity; sort the candidate images in descending order of the target similarities, to obtain a candidate image queue; and select, starting from the head of the candidate image queue, at least one candidate image as the target image satisfying the image retrieval condition.

In some embodiments, the first similarity includes a first global similarity configured to indicate an overall similarity between the candidate image and the image-text composition, and a first local similarity configured to indicate a local similarity between the candidate image and the image-text composition. The second similarity includes a second global similarity configured to indicate an overall similarity between the candidate image and the modification text, and a second local similarity configured to indicate a local similarity between the candidate image and the modification text. For each candidate image, the retrieval module 4554 is further configured to perform the following processing: determine a product of the first global similarity and the second global similarity as a first target similarity; and determine a product of the first local similarity and the second local similarity as a second target similarity; and determine a sum of the first target similarity, the second target similarity, and the first local similarity as the target similarity corresponding to the candidate image.

In some embodiments, the retrieval module 4554 is further configured to receive an image retrieval request, the image retrieval request carrying the image retrieval condition and being generated by a terminal based on an image retrieval instruction, and the image retrieval instruction being configured to instruct to perform image retrieval based on the input reference image and the input modification text; and parse the image retrieval request, to obtain the image retrieval condition.

In some embodiments, the apparatus 455 further includes a transmission module, configured to transmit the at least one target image to the terminal. The terminal displays the at least one target image.

The embodiments of the present disclosure provide a computer program product, which includes a computer program or computer-executable instructions. The computer program or computer-executable instructions are stored in a computer-readable storage medium. A processor of an electronic device reads the computer-executable instructions from the computer-readable storage medium, and executes the computer-executable instructions, to cause the electronic device to perform the image retrieval method provided in the embodiments of the present disclosure.

The embodiments of the present disclosure provide a computer-readable storage medium, which has computer-executable instructions stored therein. A processor executes the computer-executable instructions, to perform the image retrieval method provided in the embodiment of the present disclosure, such as the image retrieval method shown in FIG. 3.

In some embodiments, the computer-readable storage medium may be a memory such as an ROM, an RAM, an erasable programmable ROM (EPROM), an electronic EPROM (EEPROM), a flash memory, a magnetic surface memory, an optic disk, a compact disc ROM (CD-ROM), or the like; or may be various devices including one of or any combination of the foregoing memories.

In some embodiments, the computer-executable instructions may be written in the form of program, software, software module, script, or code by using any form of programming language (including compilation or interpretation language, or declarative or procedural language), and may be deployed in any form, including being deployed as an independent program or being deployed as a module, component, subroutine, or another unit suitable for use in a computing environment.

As an example, the computer-executable instructions may, but do not necessarily, correspond to a file in a file system, and may be stored in a part of a file that saves another program or data, for example, be stored in one or more scripts in a HyperText Markup Language (HTML) file, stored in a single file dedicated to a program in discussion, or stored in a plurality of collaborative files (for example, be stored in files of one or more modules, subprograms, or code parts).

As an example, the computer-executable instructions may be deployed to be executed on one electronic device, on a plurality of electronic devices located at one site, or on a plurality of electronic devices distributed at a plurality of locations and connected over a communication network.

In conclusion, the embodiments of the present disclosure have the following beneficial effects.

(1) The image retrieval condition including the reference image and the modification text and the plurality of candidate images are acquired, the first similarity between each candidate image and the image-text composition and the second similarity between each candidate image and the modification text are determined, and the target image satisfying the image retrieval condition is determined from the plurality of candidate images with reference to the first similarity and the second similarity. In this way, the retrieved target image satisfying the image retrieval condition is determined based on the first similarity between the candidate image and the image-text composition, which can effectively ensure that the determined target image can meet retrieval requirements of both the reference image and the modification text. In addition, the target image is also determined based on the second similarity between the candidate image and the modification text, which can enhance the impact of the modification expectation of the modification text on the determined target image. Therefore, the target image can highly satisfy the modification expectation of the modification text, and accuracy of image retrieval is effectively improved.

(2) Because the candidate images include the target image sample, the third similarities of the candidate images and the fourth similarities of the candidate images include the third similarity and the fourth similarity of the target image sample. Because the target image sample is a candidate image having the highest similarity in the candidate images, the third similarity and the fourth similarity of the target image sample may be taken as a training label to train the initial image retrieval model. In this way, the obtained image retrieval model can effectively learn a feature representation of the target image sample, and can accurately identify the corresponding target image from a huge quantity of candidate images. Therefore, retrieval performance of the image retrieval model is effectively improved.

(3) The first similarity between each candidate image and the image-text composition and the second similarity between each candidate image and the modification text are determined. Because the first similarity and the second similarity can accurately reflect the overall and local similarities between the candidate image and the image-text composition, and the overall and local similarities between the candidate image and the modification text, similarities are comprehensively measured from multiple perspectives, namely, the overall perspective and the local perspective. In this way, accuracy of the determined first similarity and second similarity is effectively improved.

(4) The first loss value of the initial image retrieval model is determined based on the third similarity corresponding to the target image sample and the third similarity corresponding to each candidate image; the second loss value of the initial image retrieval model is determined based on the fourth similarity corresponding to the target image sample and the fourth similarity corresponding to each candidate image; and weighted summation is performed on the first loss value and the second loss value, to obtain the target loss value, and the initial image retrieval model is trained based on the target loss value, to obtain the image retrieval model. Because the image retrieval model obtained through training fully utilizes the third similarity corresponding to the target image sample and the third similarity corresponding to each candidate image, retrieval performance of the image retrieval model is effectively improved.

(5) The third prediction layer is invoked, and the overall similarity between the candidate image and the modification text is predicted based on the candidate image feature and the modification text feature, to obtain the second global similarity corresponding to the candidate image; feature segmentation is performed on the modification text feature, to obtain the word feature corresponding to each word in the modification text; and the fourth prediction layer is invoked, and the local similarity between the candidate image and the modification text is predicted based on the word feature and the candidate image feature, to obtain the second local similarity corresponding to the candidate image. In this way, the second similarity is effectively determined from two different dimensions, namely, a global dimension and a local dimension, based on the determined second global similarity and second local similarity. Therefore, validity of the determined second similarity is effectively improved.

(6) The image retrieval method provided in the embodiments of the present disclosure may be implemented by using two large submodules: the feature extraction module and the similarity generation module. The feature extraction module is configured to respectively convert the feature representations of the reference image, the modification text, and the target image into the set of feature sequences, which may be further subdivided into the image encoder and the text encoder according to different forms of to-be-processed information, and are designed based on the CLIP model. The similarity generation module innovatively considers the similarity relationships between the target image and the reference image as well as the modification text, and not only designs the common similarity sᵢⱼ^{c2t} between the composed query feature (xᵢ^{r}, tᵢ^{m}) and the target image feature (xⱼ^{t}), but also calculates the individual similarity

$${s}_{ij}^{m 2 t}$$

between the modification text feature

$${t}_{i}^{m}$$

and the target image feature

$$( {x}_{j}^{t} ) .$$

Therefore, based on the basic feature that “because the target image includes semantic information of the modification text, a similarity between the modification text and the target image is relatively high”, the m2t similarity is taken as a filter to screen and filter a false target image, which improves retrieval performance.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The above are merely the embodiments of the present disclosure and are not intended to limit the scope of protection of the present disclosure. Any modification, equivalent replacement, or improvement made within the spirit and scope of the present disclosure fall within the scope of protection of the present disclosure.

What is claimed is:

1. An image retrieval method, comprising:
acquiring an image retrieval condition, the image retrieval condition comprising a reference image and modification text, the modification text being configured to indicate a modification expectation for the reference image;
composing the reference image and the modification text, to obtain an image-text composition;
acquiring a plurality of candidate images, and determining, for a candidate image, a first similarity between the candidate image and the image-text composition, and a second similarity between the candidate image and the modification text; and
determining at least one target image satisfying the image retrieval condition from the plurality of candidate images with reference to the first similarity and the second similarity.

2. The method according to claim 1, wherein determining the first similarity between the candidate image and the image-text composition, and the second similarity between the candidate image and the modification text comprises:
acquiring an image retrieval model, the image retrieval model comprising a first prediction network and a second prediction network;
respectively performing feature extraction on the reference image and the modification text, to obtain a reference image feature of the reference image and a modification text feature of the modification text, and determining a composition feature of the image-text composition with reference to the reference image feature and the modification text feature;
performing image feature extraction on the candidate image, to obtain a candidate image feature of the candidate image;
invoking the first prediction network, and predicting a similarity between the candidate image and the image-text composition based on the candidate image feature and the composition feature, to obtain the first similarity corresponding to the candidate image; and
invoking the second prediction network, and predicting a similarity between the candidate image and the modification text based on the candidate image feature and the modification text feature, to obtain the second similarity corresponding to the candidate image.

3. The method according to claim 2, wherein the first similarity comprises a first global similarity and a first local similarity, and the first prediction network comprises a first prediction layer and a second prediction layer; and
invoking the first prediction network, and predicting the similarity between the candidate image and the image-text composition based on the candidate image feature and the composition feature, to obtain the first similarity corresponding to the candidate image comprises:
invoking the first prediction layer, and predicting an overall similarity between the candidate image and the image-text composition based on the candidate image feature and the composition feature, to obtain the first global similarity corresponding to the candidate image;
performing feature segmentation on the composition feature, to obtain a plurality of local features corresponding to the composition feature, and performing feature segmentation on the modification text feature, to obtain a word feature corresponding to each word in the modification text; and
invoking the second prediction layer, and predicting a local similarity between the candidate image and the image-text composition based on the local feature and the word feature, to obtain the first local similarity corresponding to the candidate image.

4. The method according to claim 3, wherein determining the composition feature of the image-text composition with reference to the reference image feature and the modification text feature comprises:
adding the reference image feature to the modification text feature, to obtain a sum feature; and dividing the sum feature by a norm of the sum feature, to obtain the composition feature of the image-text composition; and
invoking the first prediction layer, and predicting the overall similarity between the candidate image and the image-text composition based on the candidate image feature and the composition feature, to obtain the first global similarity corresponding to the candidate image comprises:
multiplying a transposition of the composition feature by the candidate image feature, to obtain a first reference feature; and
invoking the first prediction layer, and predicting the overall similarity between the candidate image and the image-text composition based on the first reference feature, to obtain the first global similarity corresponding to the candidate image.

5. The method according to claim 3, wherein invoking the second prediction layer, and predicting the local similarity between the candidate image and the image-text composition based on the local feature and the word feature, to obtain the first local similarity corresponding to the candidate image comprises:
respectively multiplying a transposition of each word feature by the candidate image feature, to obtain a reference word feature corresponding to each word feature, and performing summation on each reference word feature, to obtain a second reference feature;
respectively multiplying a transposition of each local feature by the candidate image feature, to obtain a reference local feature corresponding to each local feature, and performing summation on each reference local feature, to obtain a third reference feature;
performing summation on the second reference feature and the third reference feature, to obtain a fourth reference feature; and
invoking the second prediction layer, and predicting the local similarity between the candidate image and the image-text composition based on the fourth reference feature, to obtain the first local similarity corresponding to the candidate image.

6. The method according to claim 2, wherein the second similarity comprises a second global similarity and a second local similarity, and the second prediction network comprises a third prediction layer and a fourth prediction layer; and
invoking the second prediction network, and predicting the similarity between the candidate image and the modification text based on the candidate image feature and the modification text feature, to obtain the second similarity corresponding to the candidate image comprises:
invoking the third prediction layer, and predicting an overall similarity between the candidate image and the modification text based on the candidate image feature and the modification text feature, to obtain the second global similarity corresponding to the candidate image;
performing feature segmentation on the modification text feature, to obtain a word feature corresponding to each word in the modification text; and
invoking the fourth prediction layer, and predicting a local similarity between the candidate image and the modification text based on the word feature and the candidate image feature, to obtain the second local similarity corresponding to the candidate image.

7. The method according to claim 6, wherein invoking the third prediction layer, and predicting the overall similarity between the candidate image and the modification text based on the candidate image feature and the modification text feature, to obtain the second global similarity corresponding to the candidate image comprises:
multiplying a transposition of the modification text feature by the candidate image feature, to obtain a fifth reference feature; and
invoking the third prediction layer, and predicting the overall similarity between the candidate image and the modification text based on the fifth reference feature, to obtain the second global similarity corresponding to the candidate image.

8. The method according to claim 6, wherein invoking the fourth prediction layer, and predicting the local similarity between the candidate image and the modification text based on the word feature and the candidate image feature, to obtain the second local similarity corresponding to the candidate image comprises:
respectively multiplying a transposition of each word feature by the candidate image feature, to obtain a reference word feature corresponding to each word feature, and performing summation on each reference word feature, to obtain a sixth reference feature; and
invoking the fourth prediction layer, and predicting the local similarity between the candidate image and the modification text based on the sixth reference feature, to obtain the second local similarity corresponding to the candidate image.

9. The method according to claim 1, wherein acquiring the image retrieval model comprises:
acquiring an image retrieval condition sample and a target image sample, the image retrieval condition sample comprising a reference image sample and a modification text sample, the modification text sample being configured to indicate a modification expectation for the reference image sample, and the target image sample satisfying the modification expectation;
composing the reference image sample and the modification text sample, to obtain an image-text composition sample;
acquiring the plurality of candidate images, the candidate images comprising the target image sample;
invoking an initial image retrieval model for each candidate image, and performing similarity prediction on the candidate image based on the candidate image, the reference image sample, and the modification text sample, to obtain a third similarity between the candidate image and the image-text composition sample, and a fourth similarity between the candidate image and the modification text sample; and
training the initial image retrieval model with reference to the third similarity and the fourth similarity, to obtain the image retrieval model.

10. The method according to claim 9, wherein training the initial image retrieval model with reference to the third similarity and the fourth similarity, to obtain the image retrieval model comprises:
determining a first loss value of the initial image retrieval model based on the third similarity corresponding to the target image sample and the third similarity corresponding to each candidate image;
determining a second loss value of the initial image retrieval model based on the fourth similarity corresponding to the target image sample and the fourth similarity corresponding to each candidate image; and
performing weighted summation on the first loss value and the second loss value, to obtain a target loss value, and training the initial image retrieval model based on the target loss value, to obtain the image retrieval model.

11. The method according to claim 1, wherein determining the at least one target image satisfying the image retrieval condition from the plurality of candidate images with reference to the first similarity and the second similarity comprises:
determining a target similarity corresponding to each candidate image with reference to the first similarity and the second similarity;
sorting the candidate images in descending order of the target similarities, to obtain a candidate image queue; and
selecting, starting from the head of the candidate image queue, the at least one candidate image as the target image satisfying the image retrieval condition.

12. The method according to claim 11, wherein the first similarity comprises the first global similarity configured to indicate the overall similarity between the candidate image and the image-text composition, and the first local similarity configured to indicate the local similarity between the candidate image and the image-text composition, and the second similarity comprises the second global similarity configured to indicate the overall similarity between the candidate image and the modification text, and the second local similarity configured to indicate the local similarity between the candidate image and the modification text; and
determining the target similarity corresponding to each candidate image with reference to the first similarity and the second similarity comprises:
respectively performing the following processing for each candidate image:
determining a product of the first global similarity and the second global similarity as a first target similarity;
determining a product of the first local similarity and the second local similarity as a second target similarity; and
determining a sum of the first target similarity, the second target similarity, and the first local similarity as the target similarity corresponding to the candidate image.

13. The method according to claim 1, wherein acquiring the image retrieval condition comprises:
receiving an image retrieval request, the image retrieval request carrying the image retrieval condition, the image retrieval request being generated by a terminal based on an image retrieval instruction, and the image retrieval instruction being configured to instruct to perform image retrieval based on the input reference image and the input modification text; and
parsing the image retrieval request, to obtain the image retrieval condition; and
after determining the at least one target image satisfying the image retrieval condition from the plurality of candidate images with reference to the first similarity and the second similarity, the method further comprises:
transmitting the at least one target image to the terminal, and displaying the at least one target image by the terminal.

14. An electronic device comprising one or more processors and a memory containing a computer program that, when being executed, causes the one or more processors to perform:
acquiring an image retrieval condition, the image retrieval condition comprising a reference image and modification text, the modification text being configured to indicate a modification expectation for the reference image;
composing the reference image and the modification text, to obtain an image-text composition;
acquiring a plurality of candidate images, and determining, for a candidate image, a first similarity between the candidate image and the image-text composition, and a second similarity between the candidate image and the modification text; and
determining at least one target image satisfying the image retrieval condition from the plurality of candidate images with reference to the first similarity and the second similarity.

15. The device according to claim 14, wherein the one or more processors are further configured to perform:
acquiring an image retrieval model, the image retrieval model comprising a first prediction network and a second prediction network;
respectively performing feature extraction on the reference image and the modification text, to obtain a reference image feature of the reference image and a modification text feature of the modification text, and determining a composition feature of the image-text composition with reference to the reference image feature and the modification text feature;
performing image feature extraction on the candidate image, to obtain a candidate image feature of the candidate image;
invoking the first prediction network, and predicting a similarity between the candidate image and the image-text composition based on the candidate image feature and the composition feature, to obtain the first similarity corresponding to the candidate image; and
invoking the second prediction network, and predicting a similarity between the candidate image and the modification text based on the candidate image feature and the modification text feature, to obtain the second similarity corresponding to the candidate image.

16. The device according to claim 15, wherein the first similarity comprises a first global similarity and a first local similarity, and the first prediction network comprises a first prediction layer and a second prediction layer; and the one or more processors are further configured to perform:
invoking the first prediction layer, and predicting an overall similarity between the candidate image and the image-text composition based on the candidate image feature and the composition feature, to obtain the first global similarity corresponding to the candidate image;
performing feature segmentation on the composition feature, to obtain a plurality of local features corresponding to the composition feature, and performing feature segmentation on the modification text feature, to obtain a word feature corresponding to each word in the modification text; and
invoking the second prediction layer, and predicting a local similarity between the candidate image and the image-text composition based on the local feature and the word feature, to obtain the first local similarity corresponding to the candidate image.

17. The device according to claim 16, wherein the one or more processors are further configured to perform:
adding the reference image feature to the modification text feature, to obtain a sum feature; and
dividing the sum feature by a norm of the sum feature, to obtain the composition feature of the image-text composition;
multiplying a transposition of the composition feature by the candidate image feature, to obtain a first reference feature; and
invoking the first prediction layer, and predicting the overall similarity between the candidate image and the image-text composition based on the first reference feature, to obtain the first global similarity corresponding to the candidate image.

18. The device according to claim 16, wherein the one or more processors are further configured to perform:
respectively multiplying a transposition of each word feature by the candidate image feature, to obtain a reference word feature corresponding to each word feature, and performing summation on each reference word feature, to obtain a second reference feature;
respectively multiplying a transposition of each local feature by the candidate image feature, to obtain a reference local feature corresponding to each local feature, and performing summation on each reference local feature, to obtain a third reference feature;
performing summation on the second reference feature and the third reference feature, to obtain a fourth reference feature; and
invoking the second prediction layer, and predicting the local similarity between the candidate image and the image-text composition based on the fourth reference feature, to obtain the first local similarity corresponding to the candidate image.

19. The device according to claim 15, wherein the second similarity comprises a second global similarity and a second local similarity, and the second prediction network comprises a third prediction layer and a fourth prediction layer; and the one or more processors are further configured to perform:
invoking the third prediction layer, and predicting an overall similarity between the candidate image and the modification text based on the candidate image feature and the modification text feature, to obtain the second global similarity corresponding to the candidate image;
performing feature segmentation on the modification text feature, to obtain a word feature corresponding to each word in the modification text; and
invoking the fourth prediction layer, and predicting a local similarity between the candidate image and the modification text based on the word feature and the candidate image feature, to obtain the second local similarity corresponding to the candidate image.

20. A non-transitory computer readable storage medium containing a computer program that, when being executed, causes at least one processor to perform:
acquiring an image retrieval condition, the image retrieval condition comprising a reference image and modification text, the modification text being configured to indicate a modification expectation for the reference image;
composing the reference image and the modification text, to obtain an image-text composition;
acquiring a plurality of candidate images, and determining, for a candidate image, a first similarity between the candidate image and the image-text composition, and a second similarity between the candidate image and the modification text; and
determining at least one target image satisfying the image retrieval condition from the plurality of candidate images with reference to the first similarity and the second similarity.
